(19) United States
(12) Patent Application Publication
(10) Pub. No.: US 2020/0234364 A1
(43) Pub. Date: Jul. 23, 2020

(54) SYSTEMS AND METHODS FOR FACILITATING BANKING TRANSACTIONS AT A POINT OF SALE DEVICE

(71) Applicant: JPMORGAN CHASE BANK, N.A., New York, NY (US)

(72) Inventors: Howard SPECTOR, Woolwich, NJ (US); Joseph R. MCCULLOUGH, Westerville, OH (US)

(21) Appl. No.: 16/744,515

(22) Filed: Jan. 16, 2020

Related U.S. Application Data
(60) Provisional application No. 62/794,039, filed on Jan. 18, 2019.

(51) Int. Cl. G06Q 40/02; G06Q 20/10

(52) U.S. Cl. CPC G06Q 40/02; G06Q 20/108

(57) ABSTRACT

Systems and methods for facilitating banking transactions at a point of sale device are disclosed. In one embodiment, in an information processing apparatus for a financial institution comprising at least one computer processor, a method for facilitating banking transactions at a third-party point of transaction device may include: (1) receiving, from a computer application executed by a customer electronic device, a request for a code to conduct a remote banking transaction with an account associated with the customer at the financial institution; (2) generating the code; (3) providing the code to the customer; (4) receiving, from a payment enabler, a banking transaction request from a third party comprising the code and a transaction amount for the banking transaction; and (5) updating a balance for the account based on the transaction amount.

### RELATED APPLICATIONS

This application claims the benefit of, and priority to, U.S. Provisional Patent Application Ser. No. 62/794,039, filed Jan. 18, 2019, the disclosure of which is hereby incorporated, by reference, in its entirety.

### BACKGROUND OF THE INVENTION

### 1. Field of the Invention

Embodiments relate generally to systems and methods for facilitating banking transactions at a point of sale device.

### 2. Description of the Related Art

It is difficult for an individual that is away from a branch to interact with their financial institution. For example, an individual away from a branch wanting to withdraw money from their account may need to use a different bank's ATM, which may lead to surcharges.

### SUMMARY OF THE INVENTION

Systems and methods for facilitating banking transactions at a point of sale device are disclosed. In one embodiment, in an information processing apparatus for a financial institution comprising at least one computer processor, a method for facilitating banking transactions at a third-party point of transaction device may include: (1) receiving, from a computer application executed by a customer electronic device, a request for a code to conduct a remote banking transaction with an account associated with the customer at the financial institution; (2) generating the code; (3) providing the code to the customer; (4) receiving, from a payment enabler, a banking transaction request from a third party comprising the code and a transaction amount for the banking transaction; and (5) updating a balance for the account based on the transaction amount.

In one embodiment, the remote banking transaction may include a deposit, a withdrawal, or a cash drop.

In one embodiment, the remote banking transaction may include a payment.

In one embodiment, the code may include a one-time code, a multi-use code, etc.

In one embodiment, the code may include an indicator that routes the banking transaction from the third party to the payment enabler.

In one embodiment, the third party may include a retailer.

According to another embodiment, in an information processing apparatus for a payment enabler comprising at least one computer processor, a method for facilitating banking transactions at a third-party point of transaction device may include: (1) receiving, from a financial institution, a code for conducting a remote banking transaction with an account associated with the customer at the financial institution; (2) receiving, from a third party, a banking transaction request comprising the code and a transaction amount for the banking transaction; (3) identifying the financial institution from the code; (4) authorizing the banking transaction; (5) receiving confirmation from the third party that the banking transaction is complete; and (6) notifying the financial institution that the banking transaction is complete.

In one embodiment, the remote banking transaction may include a deposit, a withdrawal, or a cash drop.

In one embodiment, the remote banking transaction may include a payment.

In one embodiment, the code may include a one-time code, a multi-use code, etc.

In one embodiment, the code may include an indicator that routes the banking transaction from the third party to the payment enabler.

In one embodiment, the third party may include a retailer.

In one embodiment, notifying the financial institution that the banking transaction is complete may include communicating a received money amount to the financial institution.

According to another embodiment, in an information processing apparatus for a third party comprising at least one computer processor, a method for facilitating banking transactions at a third-party point of transaction device may include: (1) receiving, from a customer and during a transaction with the customer, a code for a remote banking transaction with an account associated with the customer at the financial institution and a transaction amount; (2) identifying a payment enabler and the transaction as a remote banking transaction based on the code; (3) communicating the code and the transaction amount to the payment enabler; (4) receiving authorization for the transaction from the payment enabler; (5) conducting the transaction with the customer; and (6) notifying the payment enabler that the transaction is complete.

In one embodiment, the remote banking transaction may include a deposit, a withdrawal, a cash drop, or a payment.

In one embodiment, the code may include an indicator that routes the banking transaction from the third party to the payment enabler.

In one embodiment, the indicator may include a bank identification number.

In one embodiment, the third party may include a retailer.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 depicts a system for facilitating banking transactions at a point of sale device according to one embodiment;

FIG. 2 depicts a method for facilitating banking transactions at a point of sale device according to one embodiment;

FIG. 3 depicts a method for facilitating banking transactions at a point of sale device according to anther embodiment; and

FIG. 4 depicts an exemplary process flow for facilitating banking transactions at a point of sale device according to anther embodiment.

### DETAILED DESCRIPTION OF PREFERRED EMBODIMENTS

Embodiments are directed to systems and methods for facilitating banking transactions at a point of sale device for a merchant or retailer.

In embodiments, a code, such as a machine-readable code (e.g., a bar code, a QR code, etc.), a NFC code, a Bluetooth code, a numeric code, an audible code, etc. may be used to identify a customer and support a banking interaction from a non-bank location such as a convenience store, a supermarket, a kiosk, etc. Any retailer location may participate as is necessary and/or desired.

In one embodiment, a customer may request the code from a financial institution for a banking transaction (e.g., a deposit, a withdrawal, a transfer, etc.). The customer may then present the code to the retailer at, for example, a point of sale device, and the retailer may then communicate the code to the financial institution. The financial institution may authorize the banking transaction with the retailer, and the retailer may then conduct the banking transaction with the customer (e.g., receive money or checks from the customer for a deposit to an account, provide money to the customer for a withdrawal from an account, etc.).

In one embodiment, the code may be presented to a transaction device at a non-bank location, such as a point of sale device, a vending-type machine, any device with a camera and the ability to accept or dispense currency, etc.

In one embodiment, the backend may support adding or depositing funds to a checking account, a savings account, a brokerage account, or any other online financial account. In one embodiment, the backend may further support adding funds to an investment account.

In one embodiment, the code may directly or indirectly identify the financial institution, the account(s) involved, the banking transaction type, and the banking transaction amount. In one embodiment, the banking transaction amount may be specified when the customer interacts with the retailer.

In one embodiment, the code may be a temporary (e.g., one-time code). In another embodiment, the code may be used multiple times. The code may change as is necessary and/or desired.

In one embodiment, the code may be limited to a certain type of transaction (e.g., for deposit transactions only).

In one embodiment, the code may be used for the financial institution's partner merchants to receive cash payments and/or deposits.

In one embodiment, the code may be based on characteristics of the customer, account and/or device. For example, a first code may be provided for paper statements, and a second code may be provided for mobile devices so that the financial institution backend can identify the source of the code. In one embodiment, the encoding may be part of the front-end processing.

In one embodiment, a payment enabler may be provided, and the customer or the financial institution may request the code from the payment enabler. The payment enabler may be integrated with the retailer such that once the retailer receives the code, the retailer may provide the code to the payment enabler, which may then identify the financial institution and/or accounts, and may authorize the banking transaction with the financial institution.

In one embodiment, the backend may support daily cash drops from cash-based businesses. For example, at the end of the business day, the customer may go to a retailer location, provide a code that identifies the financial institution and account for the funds to be deposited, and provide the funds to the retailer. After authorizing the deposit transaction, the retailer may receive the funds and indicate the receipt of such directly or indirectly to the financial institution, and may deposit the funds with the retailer's bank. The financial institution may then credit the customer's account with the amount of deposit upon notification, or the financial the institution may wait until the funds have been received from the retailer or the retailer's bank.

In one embodiment, the backend may enable the use of the code for donations or charitable giving. For example, the backend may generate a code that may be provided on a mobile device screen, printed on paper, etc., for a donation to a charity, cause, etc. To donate, the customer may scan the code at the retailer location, and the funds will be transferred from the customer's account to the charity account.

In one embodiment, a user may generate a code to allow people to pay them or to collect funds from them. For example, a small business owner may provide its customers with a code that identifies the small business owner's account, and the customers may pay the small business owner by scanning the code at a third-party retailer. Once scanned and approved, the retailer or the retailer's bank may transfer the funds to the small business owner's account, and the customer may pay in any suitable fashion.

In one embodiment, a college student may use a code in a similar manner to receive college funds, gifts, etc. A child may give a code to his or her grandparents to receive gifts.

In one embodiment, a small business owner may generate a code and provide the code to employees so that the employees can reimburse the business for any personal transactions conducted with the small businesses credit card or other accounts.

In one embodiment, the code may be associated with a customer account with a transportation system (e.g., EZPass, subways, etc.), parking systems, garages, etc. and may fund those accounts.

In another embodiment, the code may identify the charity account. For example, the code may be scanned, and after the customer provides the donation amount (e.g., cash, credit card payment, etc.), the donation amount is identified to the backend, which may cause the funds to be deposited to the charity account.

In one embodiment, the code may be used to provide anonymous cash transfers to those in need, such as the homeless, people displaced by natural disasters, etc. In one embodiment, a code may be distributed to those in need, and may be presented at a retailer to receive funds from, for example, a master charitable account.

In one embodiment, know your customer (KYC) or anti-money laundering (AML) policies may be applied by the financial institution's backend as part of approving the banking transaction. Embodiments may enable the collection of the funds; however, the funds may not be made directly available to the customer until any KYC/AML concerns are addressed. In the case of an AML/KYC issue, embodiments may return the funds to the initiating customer. The return may be electronic, may use the cash out embodiment discussed herein, may be delivered by more traditional methods such as a paper check or cash at a branch, etc.

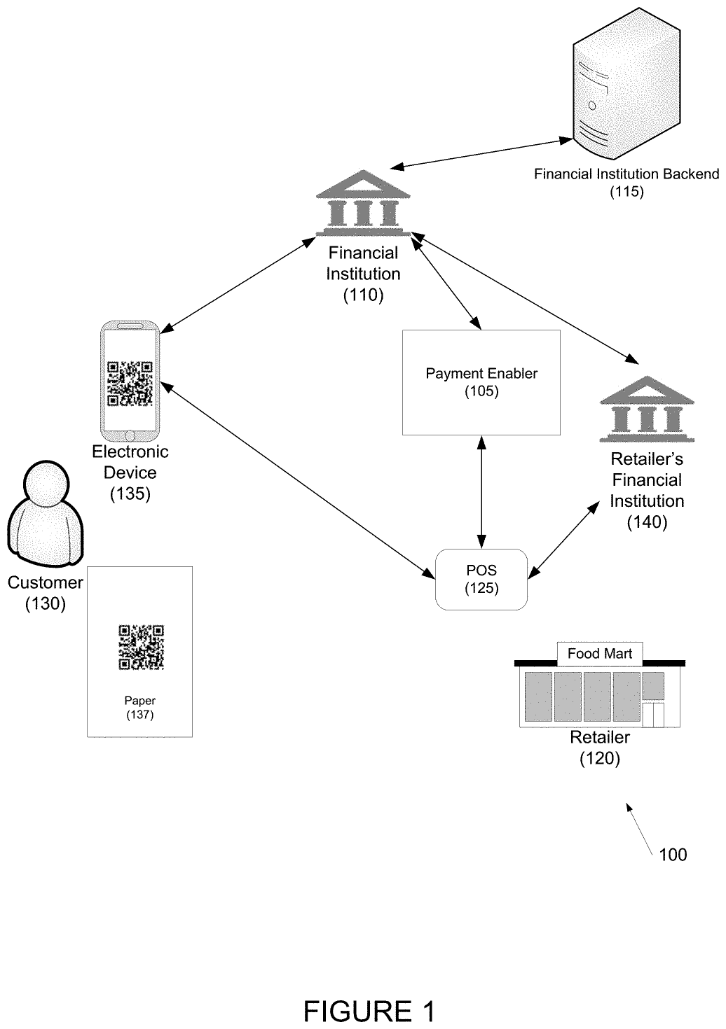

Referring to FIG. 1, a system for facilitating banking transactions at a point of sale device is disclosed at one embodiment. System 100 may include payment enabler 105, financial institution 110, financial institution backend 115, retailer 120, retailer point of sale device 125, retailer's financial institution 140, and electronic device 135 associated with customer 130. In one embodiment, instead of electronic device 135, customer 130 may present a code printed on paper 137.

In embodiments, financial institution backend 115 may perform routing to one or more accounts that will be funded or paid. In addition, customer 130 may have instructions codified on financial institution backend 115 and then executed once the transaction occurs. This may include, for example, setting up multiple payments, deposits, splitting the transaction, etc.

In one embodiment, customer 130 may request a person-to-person (P2P) payment, and may be given code (e.g., an optical code such as a bar code or QR code, a NFC code, alphanumeric number, etc.) that customer 130 may give to a third party (not shown) to initiate the transfer. In another embodiment, customer 130 may request or send funds from the third party, and financial institution backend 115 may use a P2P payment provider (e.g., Zelle, etc.) to move the received cash to the proper recipient.

In one embodiment, customer 130 may set time limits and/or dollar thresholds on the transaction. For example, the threshold may require a certain amount of funds to be accumulated before funds are delivered, to stop delivering funds, to refuse a deposit once a dollar amount is reached (e.g., when a debt is fulfilled), etc.

In one embodiment, electronic device 135 may be any suitable electronic device, including smart phones, tablet computers, smart watches, notebook computers, desktop computers, e-readers, Internet of Things (“IoT”) appliances, etc.

In one embodiment, customer 130 may present a code displayed on electronic device 135 or paper 137 to retailer POS 125. In one embodiment, the code may identify one or more of financial institution 110, a banking transaction account, a banking transaction type, a transaction amount, etc. In one embodiment, customer 130 may pre-stage a banking transaction with financial institution 110.

Payment enabler 105 may facilitate the transfer of funds from retailer 120 or retailer's financial institution 140 to financial institution 110. For example, payment enabler 105 may provide technology that allows cash transactions at a point of sale to be transformed into payments or digital currency.

In one embodiment, payment enabler 105 may be part of, or hosted by, financial institution 110.

In one embodiment, payment enabler 105 may generate the code for financial institution 110, and may receive the code from retailer POS 125 when it is presented by customer 130.

Financial institution backend 115 may receive information regarding the funds transfer and may process it appropriately (e.g., deposit to the proper account, withdraw from the proper account, etc.).

In one embodiment, the customer may use the code to withdraw or receive funds from the customer's account or a third-party account, to deposit funds to a customer's account or a third-party account, etc.

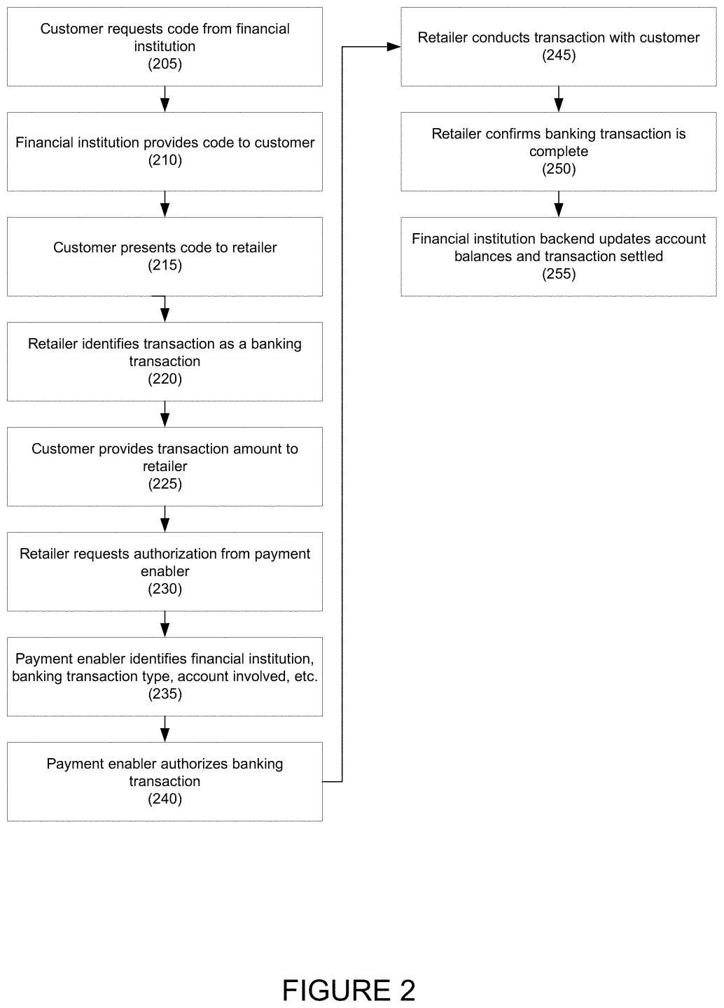

Referring to FIG. 2, a method for facilitating banking transactions at a point of sale device is disclosed according to one embodiment. In optional step 205, a customer may request a code from a financial institution with which the customer may have an account. In one embodiment, the customer may identify the type of transaction (e.g., withdrawal, deposit, cash drop, etc.), and the source or destination account. In one embodiment, the request may include the amount of the transaction; in another embodiment, the customer may provide the amount of the transaction when the customer presents the code to the retailer.

In one embodiment, the account may be a credit account, a debit account, an investment account, an insurance account (e.g., home, auto, etc.), and the customer may make a deposit or payment to the account using the code.

In another embodiment, the customer may request a code for a repeated transaction (e.g., nightly deposits).

In one embodiment, the customer may request the code using a mobile electronic device (e.g., an application or computer program executed by the mobile electronic device), via a website, via an IoT device, etc.

In one embodiment, the financial institution may authenticate the customer and may apply KYC and/or AML rules to the transaction. It may also apply velocity rules for transactions involving the account, fraud rules, etc. The financial institution may further apply limits on a transaction amount (e.g., per transaction, per day, etc.), limits on the number pf transactions per day, limits on the types of transactions, etc.

In one embodiment, the financial institution may generate the code and may provide the code to a payment enabler.

In another embodiment, the financial institution may request the code from the payment enabler, and the payment enabler which may provide the code to the financial institution. For example, the financial institution may make an API call to the payment enabler for the code.

In step 210, the financial institution may provide the code to the customer. In one embodiment, the code may be provided to the customer's electronic device, may be printed on a statement (e.g., an account statement), may be provided separately (e.g., printed on an account card), etc.

In one embodiment, the code may be a single-use code; in another embodiment, it may be a multi-use code. The multi-use code may be limited to a certain type of transaction (e.g., deposits only).

In step 215, the customer may present the code to a retailer that may participate with the payment enabler's services. In one embodiment, the code may be presented as a barcode, QR code, NFC code, Bluetooth code, an alphanumeric code, etc.

In step 220, the retailer may identify the transaction as a banking transaction involving the payment enabler. For example, the code, or a part of the code (e.g., the BIN), or any other suitable indicator may identify the transaction as a banking transaction. The retailer may then provide the code to the payment enabler.

In step 225, the customer may provide a transaction amount to the retailer. For example, the customer may identify an amount of money to withdraw, or may present an amount to be deposited in the form of cash and/or checks to the retailer.

In step 230, the retailer may request authorization for the transaction from the payment enabler by providing the code to the payment enabler. The retailer may also provide the amount of the transaction.

In step 235, from the code, the payment enabler may identify the financial institution and the banking transaction type, and may submit the banking transaction to the financial institution. In one embodiment, the payment enabler may provide the code to the financial institution, and the financial institution may identify the amount. The payment enabler may also provide the transaction amount, etc.

In one embodiment, the payment enabler may apply authorization rules and may contact the customer's financial institution for its rules before approving the transaction.

In step 240, the financial institution may receive the banking transaction and may authorize the banking transaction. In one embodiment, the financial institution may identify the account for the banking transaction by matching the code received from the payment enabler with the banking transaction to the code received from the payment enabler when the code was requested.

In one embodiment, the financial institution may apply velocity, KYC and/or AML rules to the transaction. It may also apply limits on a transaction amount (e.g., per transaction, per day, etc.), limits on the number pf transactions per day, limits on the types of transactions, etc.

In step 245, the retailer may conduct the banking transaction with the customer. In one embodiment, the retailer may confirm receipt of the funds for a deposit, may hand the customer cash for a withdrawal, etc.

In step 250, the retailer may confirm that the banking transaction is complete with the financial institution.

In step 255, the financial institution backend may update account balances and conduct any other actions as is necessary and/or desired. The transaction may be settled (e.g., the retailer or the retailer's bank may settle with the payment enabler, and the payment enabler may settle with the financial institution).

For example, the customer may apply the funds received to a credit account, a debit account, an investment account, an insurance account, etc.

In one embodiment, the financial institution may immediately credit an account with a deposit, or it may hold crediting at least a portion of the deposit amount for settlement. The amount that is held, if any, may be based on an account type, a risk profile associated with the customer, etc.

In one embodiment, the financial institution may provide this service for cash drops, and the cash may be logically secured by the financial institution when the retailer receives the code and the funds. The funds may then be credited to the user's account in real time, in a configurable amount of time.

In another embodiment, the user may withdraw funds necessary to conduct business in a similar manner.

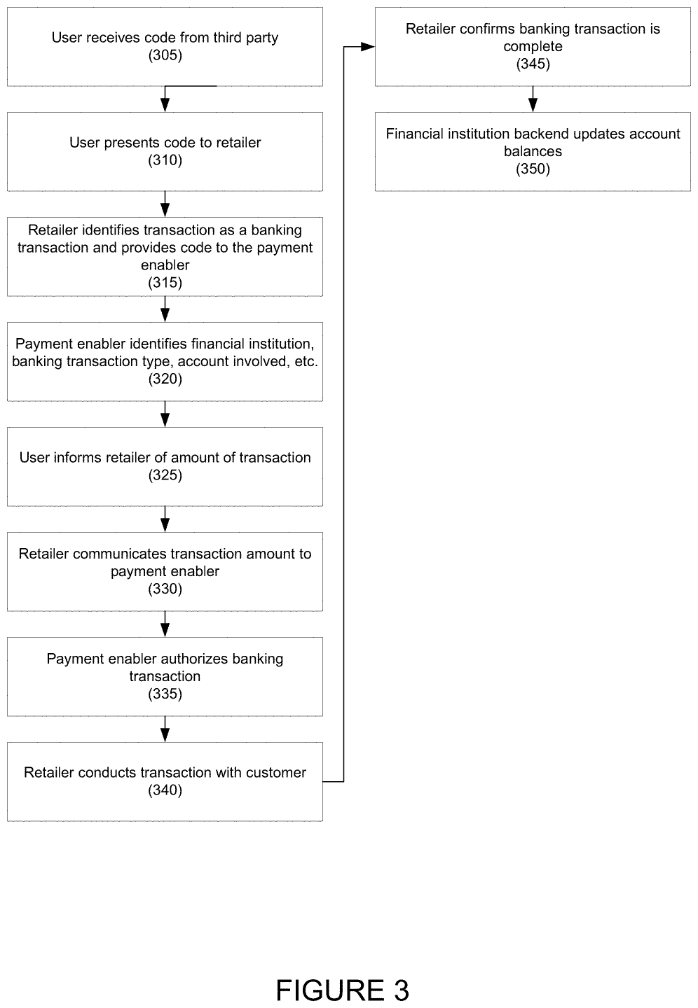

Referring to FIG. 3, a method for facilitating banking transactions at a point of sale device is disclosed according to another embodiment.

In step 305, a user may receive a code from a third party. In one embodiment, the code may identify an account from which funds are to be deposited, or from where funds may be withdrawn. For example, the user may use the code to deposit funds to the third party's account, or to receive funds from the third party's account.

In one embodiment, the third party may be a retailer or merchant, a good or service provider, etc.

In one embodiment, the code may be associated with the user's employer, and the user may use the code to reimburse the employer for personal transactions made using an account associated with the employer. For example, the user may reimburse the employer for purchases made with the employer's corporate credit card, mailroom services, etc.

In one embodiment, the code may be provided to an electronic device to be displayed or transmitted, on paper (e.g., on a statement, on a card, etc.), etc.

In step 310, the user may present the code to a retailer. In one embodiment, the code may be presented as a barcode, QR code, NFC code, Bluetooth code, an alphanumeric code, etc.

In one embodiment, the code may be presented as a normal transaction with the retailer. For example, if the user is at a grocery store, the retailer may scan the code in the same manner that the retailer would scan a UPC code for a product being sold.

In one embodiment, the retailer may subscribe to the payment enabler's services.

In step 315, the retailer may identify the transaction as a banking transaction involving the payment enabler. For example, the code, or a part of the code (e.g., the BIN), or any other suitable indicator may identify the transaction as a banking transaction. The retailer may then provide the code to the payment enabler.

In step 320, the payment enabler may identify the financial institution and the banking transaction type. In one embodiment, the payment enabler may also identify the account involved, etc.

In step 325, the retailer may receive an amount of the transaction from the user, and, in step 330, may communicate the amount to the payment enabler.

In step 335, the payment enabler may receive the transaction and may authorize the banking transaction.

In one embodiment, for a deposit, the payment enabler may transfer the amount of the transaction via ACH to a holding account, which may then be transferred to the third party financial institution.

In step 340, the retailer may conduct the banking transaction with the user. In one embodiment, the retailer may confirm receipt of the funds for a deposit, may hand the user cash for a withdrawal, etc.

In step 345, the retailer may confirm that the banking transaction is complete with the financial institution.

In step 350, the financial institution backend may update account balances and conduct any other actions as is necessary and/or desired. The transaction may then be settled. This may be similar to step 245, above.

Examples of banking transactions that may be conducted include deposits using a text or barcode on a statements or other customer correspondence, adding funds to a checking or savings account, including credit, co-brand, and stored value cards managed by the financial institution, adding funds to an investment account, funding a savings goal, making a loan payment, using the code to enable deposits to an account (e.g., grandparents adding money to a child's saving account, etc.), paying bills from participating merchants, employees reimbursing a business for personal expenses, funding a transportation account with an in-store payment, cash drops (e.g., cash-based business not near a financial institution branch may deposit the daily funds into their account using a code), facilitating merchant funded offers match from merchant (e.g., if you use this service at a specific merchant, you will receive merchant or financial institution rewards, discounts, cash back, etc.), funding charitable accounts, making donations, cashing out, out-of-market withdrawals, enabling P2P transactions, etc.

In one embodiment, for merchant-funded offers, the amount of the merchant funded offer may be credited against a savings goal. For example, if a customer had a savings goal set up (e.g., for an item on an Amazon wish list), and the customer uses an offer-linked credit card to purchase something else at Amazon, the merchant funded offer amount may be credited toward the savings goal.

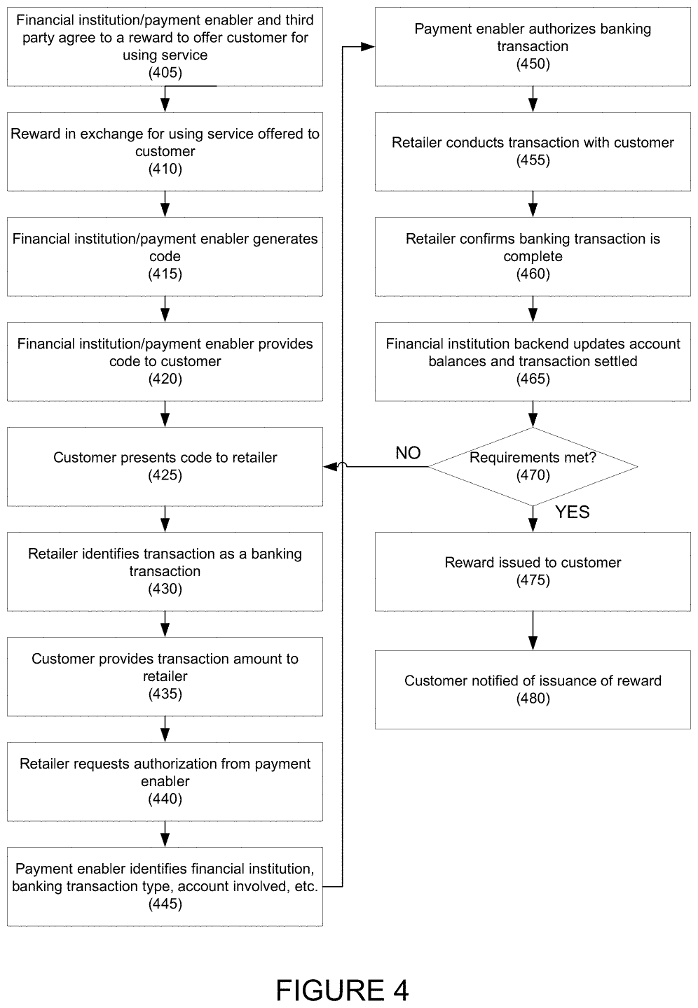

Referring to FIG. 4, exemplary process flows for merchant integration are disclosed according to another one embodiment.

In step 405, a financial institution or a payment enabler may agree to a reward to offer a customer in exchange for the customer using the service. In one embodiment, the offer may be based on type of action taken (e.g., deposit, withdrawal, bill payment, etc.) and a number of times that the action(s) is taken.

In one embodiment, the reward may be issued by the third party.

In another embodiment, the reward may be issued by the financial institution; thus, no agreements may be necessary.

Other factors, such as when the reward is issued, whether the offer is presented to the user before it is earned or whether it is a surprise, etc. may be established.

In step 410, the offer for the reward in exchange may be presented to the customer. In one embodiment, if the reward is to be a surprise, the offer may not be presented to the customer.

If the offer is presented to the customer, the terms for the offer (e.g., required activities to complete, number of time to complete the activities, etc.) may be presented.

In one embodiment, the customer may accept the offer before the offer is a “live” offer.

In step 415, the financial institution or payment enabler may generate a code for the customer. In one embodiment, the code may be link the customer to the offer and reward.

In one embodiment, the financial institution may generate the code and may provide the code to a payment enabler.

In another embodiment, the financial institution may request the code from the payment enabler, and the payment enabler which may provide the code to the financial institution. For example, the financial institution may make an API call to the payment enabler for the code.

In step 420, the financial institution may provide the code to the customer. In one embodiment, the code may be provided to the customer's electronic device, may be printed on a statement (e.g., an account statement), may be provided separately (e.g., printed on an account card), etc.

In step 425, the customer may present the code to a retailer that may participate with the payment enabler's services. In one embodiment, the code may be presented as a barcode, QR code, NFC code, Bluetooth code, an alphanumeric code, etc.

In step 430, the retailer may identify the transaction as a banking transaction involving the payment enabler. For example, the code, or a part of the code (e.g., the BIN), or any other suitable indicator may identify the transaction as a banking transaction. The retailer may then provide the code to the payment enabler.

In step 435, the customer may provide a transaction amount to the retailer. For example, the customer may identify an amount of money to withdraw, or may present an amount to be deposited in the form of cash and/or checks to the retailer.

In step 440, the retailer may request authorization for the transaction from the payment enabler by providing the code to the payment enabler. The retailer may also provide the amount of the transaction.

In step 445, from the code, the payment enabler may identify the financial institution and the banking transaction type, and may submit the banking transaction to the financial institution. In one embodiment, the payment enabler may provide the code to the financial institution, and the financial institution may identify the amount. The payment enabler may also provide the transaction amount, etc.

In one embodiment, the payment enabler may apply authorization rules and may contact the customer's financial institution for its rules before approving the transaction.

In step 450, the financial institution may receive the banking transaction and may authorize the banking transaction. In one embodiment, the financial institution may identify the account for the banking transaction by matching the code received from the payment enabler with the banking transaction to the code received from the payment enabler when the code was requested.

In step 455, the retailer may conduct the banking transaction with the customer. In one embodiment, the retailer may confirm receipt of the funds for a deposit, may hand the customer cash for a withdrawal, etc.

In step 460, the retailer may confirm that the banking transaction is complete with the financial institution.

In step 465, the financial institution backend may update account balances and conduct any other actions as is necessary and/or desired. The transaction may be settled (e.g., the retailer or the retailer's bank may settle with the payment enabler, and the payment enabler may settle with the financial institution).

In step 470, if the requirements of the offer are met (e.g., action type(s), number of actions, etc.), in step 475, the reward may be issued to the customer. The timing of the reward issuance may be dictated by the agreement between the financial institution or payment enabler and the third party.

In step 480, the customer may be informed of the issuance of the reward. In one embodiment, the customer may be informed by message (e.g., SMS, email, push-based messaging, etc.), voice message (e.g., automated voice messaging), in-app messaging, etc.

If, in step 470, the requirements are not met, the process may return to step 425.

Although several embodiments have been disclosed, it should be recognized that these embodiments are not exclusive to each other, and certain elements or features from one embodiment may be used with another.

Hereinafter, general aspects of implementation of the systems and methods of the invention will be described.

The system of the invention or portions of the system of the invention may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system. Thus, embodiments of the invention may include a processing machine running the iOS operating system, the OS X operating system, the Android operating system, the Microsoft Windows™ operating systems, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for facilitating banking transactions at a third-party point of transaction device comprising:
in an information processing apparatus for a financial institution comprising at least one computer processor:
receiving, from a computer application executed by a customer electronic device, a request for a code to conduct a remote banking transaction with an account associated with the customer at the financial institution;
generating the code;
providing the code to the customer;
receiving, from a payment enabler, a banking transaction request from a third party comprising the code and a transaction amount for the banking transaction; and
updating a balance for the account based on the transaction amount.

2. The method of claim 1, wherein the remote banking transaction comprises a deposit, a withdrawal, or a cash drop.

3. The method of claim 1, wherein the remote banking transaction comprises a payment.

4. The method of claim 1, wherein the code comprises a one-time code.

5. The method of claim 1, wherein the code comprises a multi-use code.

6. The method of claim 1, wherein the code comprises an indicator that routes the banking transaction from the third party to the payment enabler.

7. The method of claim 1, wherein the third party comprises a retailer.

8. A method for facilitating banking transactions at a third-party point of transaction device comprising:
in an information processing apparatus for a payment enabler comprising at least one computer processor:
receiving, from a financial institution, a code for conducting a remote banking transaction with an account associated with the customer at the financial institution;
receiving, from a third party, a banking transaction request comprising the code and a transaction amount for the banking transaction;
identifying the financial institution from the code;
authorizing the banking transaction;
receiving confirmation from the third party that the banking transaction is complete; and
notifying the financial institution that the banking transaction is complete.

9. The method of claim 8, wherein the remote banking transaction comprises a deposit, a withdrawal, or a cash drop.

10. The method of claim 8, wherein the remote banking transaction comprises a payment.

11. The method of claim 8, wherein the code comprises a one-time code.

12. The method of claim 8, wherein the code comprises a multi-use code.

13. The method of claim 8, wherein the code comprises an indicator that routes the banking transaction from the third party to the payment enabler.

14. The method of claim 8, wherein the third party comprises a retailer.

15. The method of claim 8, wherein notifying the financial institution that the banking transaction is complete comprises:
communicating a received money amount to the financial institution.

16. A method for facilitating banking transactions at a third-party point of transaction device comprising:
in an information processing apparatus for a third party comprising at least one computer processor:
receiving, from a customer and during a transaction with the customer, a code for a remote banking transaction with an account associated with the customer at the financial institution and a transaction amount;
identifying a payment enabler and the transaction as a remote banking transaction based on the code;
communicating the code and the transaction amount to the payment enabler;
receiving authorization for the transaction from the payment enabler;
conducting the transaction with the customer; and
notifying the payment enabler that the transaction is complete.

17. The method of claim 16, wherein the remote banking transaction comprises a deposit, a withdrawal, a cash drop, or a payment.

18. The method of claim 16, wherein the code comprises an indicator that routes the banking transaction from the third party to the payment enabler.

19. The method of claim 16, wherein the indicator comprises a bank identification number.

20. The method of claim 163, wherein the third party comprises a retailer.
